(19) United States
(12) Patent Application Publication
(10) Pub. No.: US 2026/0122190 A1
(43) Pub. Date: Apr. 30, 2026

(54) INFORMATION PROCESSING TERMINAL, TRANSMISSION METHOD, AND NON-TRANSITORY COMPUTER-READABLE STORAGE MEDIUM STORING PROGRAM

(71) Applicant: SEIKO EPSON CORPORATION, TOKYO (JP)

(72) Inventors: Takuya YAMASHITA, MATSUMOTO-SHI (JP); Yuichi SUGIYAMA, SHIOJIRI-SHI (JP); Ryo ITO, MATSUMOTO-SHI (JP)

(21) Appl. No.: 19/373,860

(22) Filed: Oct. 30, 2025

(30) Foreign Application Priority Data
Oct. 31, 2024 (JP) 2024-191547

(51) Int. Cl. H04N 1/00; H04N 1/32

(52) U.S. Cl. CPC H04N 1/00464; G06F 3/1237; H04N 1/32106

(57) ABSTRACT

An information processing terminal executes a first step of displaying a Web application screen using a function of a native application and receiving a job image. The information processing terminal executes a second step of displaying the Web application screen using a function of an internal browser and receiving management information. The information processing terminal executes a third step of transmitting the management information, input of which has been received using the function of the internal browser, to a server. The information processing terminal executes a fourth step of transmitting the job image to the server using the function of the native application without using the function of the internal browser.

The present application is based on, and claims priority from JP Application Serial Number 2024-191547, filed Oct. 31, 2024, the disclosure of which is hereby incorporated by reference herein in its entirety.

### BACKGROUND

### 1. Technical Field

The present disclosure relates to an information processing terminal, a transmission method, and a non-transitory computer-readable storage medium storing a program.

### 2. Related Art

JP-A-2023-128286 discloses a print job management system that causes a printing apparatus to execute a print job. In the print job management system disclosed in JP-A-2023-128286, an administrator operates an administrator terminal to input information indicating content of a requested matter. The administrator terminal transmits the information to a print job management apparatus. The print job management apparatus generates a print job for performing printing corresponding to the requested matter and instructs an information processing apparatus to execute the print job. The information processing apparatus generates print data by performing processing for executing the print job and causes the printing apparatus to execute printing based on the print data.

JP-A-2023-128286 is an example of the related art.

In the technique disclosed in JP-A-2023-128286, when a processing target job file is transmitted to the server that provides a Web application, operation of a user is likely to be complicated. Therefore, when the processing target job file is transmitted to the server that provides the Web application, it is desired to simplify the operation of the user.

### SUMMARY

According to an aspect of the present disclosure, there is provided a first transmission method including: a first step of receiving designation of a job image, which is a printing target image, using a function of a native application that operates in an information processing terminal; a second step of displaying, using a function of an internal browser that cooperates with the native application, a Web application screen that is a screen of a Web application provided in a print server that is capable of communicating with the information processing terminal via a network and performs processing concerning printing for the job image and receiving, on the Web application screen, input of management information used for management of the job image, the designation of which was received in the first step; a third step of transmitting, to the print server, the management information, the input of which was received in the second step using the function of the internal browser; and a fourth step of transmitting, to the print server, the job image, the designation of which was received in the first step, using the function of the native application without using the function of the internal browser.

According to an aspect of the present disclosure, there is provided an information processing terminal including: a job image reception unit configured to receive designation of a job image, which is a printing target image, using a function of a native application that operates in the information processing terminal; a management information reception unit configured to display, using a function of an internal browser that cooperates with the native application, a Web application screen that is a screen of a Web application provided in a print server that is capable of communicating with the information processing terminal via a network and performs processing concerning printing for the job image and receive, on the Web application screen, input of management information used for management of the job image, the designation of which was received; a management information transmission unit configured to transmit, to the print server, the management information, the input of which was received using the function of the internal browser; and a job image transmission unit configured to transmit, to the print server, the job image, the designation of which was received, using the function of the native application without using the function of the internal browser.

According to an aspect of the present disclosure, there is provided a non-transitory computer-readable storage medium storing a program for causing a computer to execute: a first step of receiving designation of a job image, which is a printing target image, using a function of a native application that operates in an information processing terminal; a second step of displaying, using a function of an internal browser that cooperates with the native application, a Web application screen that is a screen of a Web application provided in a print server that is capable of communicating with the information processing terminal via a network and performs processing concerning printing for the job image and receiving, on the Web application screen, input of management information used for management of the job image, the designation of which was received in the first step; a third step of performing processing for transmitting, to the print server, the management information, the input of which was received using the function of the internal browser; and a fourth step of performing processing for transmitting, to the print server, the job image, the designation of which was received in the first step, using the function of the native application without using the function of the internal browser.

According to an aspect of the present disclosure, there is provided a second transmission method including: a first step of receiving designation of a processing target job file using a function of a native application that operates in an information processing terminal; a second step of displaying, using a function of an internal browser that cooperates with the native application, a Web application screen that is a screen of a Web application provided in a server that is capable of communicating with the information processing terminal via a network and performs processing concerning a job for the job file and receiving, on the Web application screen, input of management information used for management of the job file, the designation of which was received in the first step; a third step of transmitting, to the server, the management information, the input of which was received in the second step using the function of the internal browser; and a fourth step of transmitting, to the server, the job file, the designation of which was received in the first step, using the function of the native application without using the function of the internal browser.

### BRIEF DESCRIPTION OF THE DRAWINGS

FIG. 1 is a diagram illustrating a management system according to an embodiment.

FIG. 2 is a diagram illustrating an overview of an information processing terminal according to the embodiment.

FIG. 3 is a flowchart illustrating a transmission method according to the embodiment.

FIG. 4 is a diagram illustrating a hardware configuration of an information processing terminal according to a first embodiment.

FIG. 5 is a diagram illustrating elements of the information processing terminal according to the first embodiment.

FIG. 6 is a diagram illustrating a configuration of a server according to the first embodiment.

FIG. 7 is a sequence diagram illustrating processing executed by a management system according to the first embodiment.

FIG. 8 is a diagram exemplifying a native application screen displayed on the information processing terminal according to the embodiment.

FIG. 9 is a diagram exemplifying a Web application screen displayed on the information processing terminal according to the embodiment.

FIG. 10 is a diagram exemplifying a Web application screen displayed by the server according to the embodiment.

FIG. 11 is a diagram exemplifying a Web application screen displayed by a Web browser in a comparative example.

FIG. 12 is a diagram illustrating elements of an information processing terminal according to a second embodiment.

FIG. 13 is a diagram illustrating a configuration of a server according to the second embodiment.

FIG. 14 is a sequence diagram illustrating processing executed by a management system according to the second embodiment.

### DESCRIPTION OF EMBODIMENTS

### Overview of an Embodiment

An embodiment is explained below with reference to the drawings. To clarify the explanation, the following description and the drawings are omitted or simplified as appropriate. In the drawings, the same elements are denoted by the same reference numerals and signs and redundant explanation of the elements is omitted according to necessity. First, an overview of the present embodiment is explained.

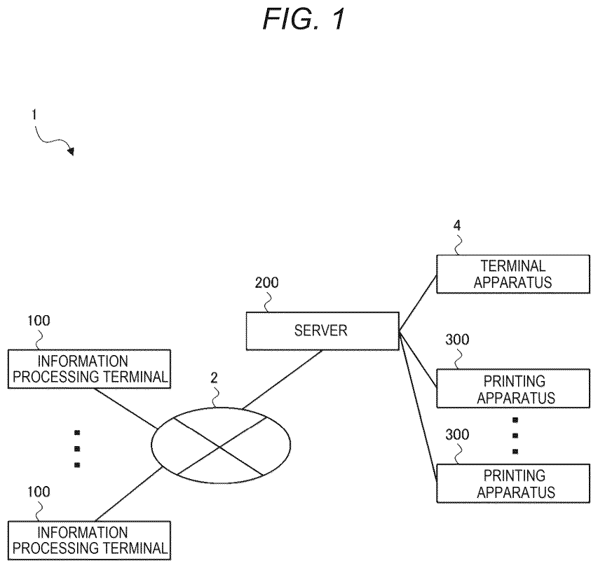

FIG. 1 is a diagram illustrating a management system 1 according to the present embodiment. The management system 1 includes one or more information processing terminals 100, a server 200, one or more printing apparatuses 300, and a terminal apparatus 4. The information processing terminal 100 and the server 200 are communicably connected to each other via a network 2 such as the Internet. The server 200 is communicably connected to the terminal apparatus 4 and the printing apparatus 300. The information processing terminal 100 may be communicably connected to the terminal apparatus 4 and the printing apparatus 300. The server 200 may be a print server that provides a service concerning printing executed in the printing apparatus 300 but is not limited thereto. In the following explanation, an example in which the server 200 is a print server is explained.

The management system 1 manages a print job concerning printing executed in the printing apparatus 300. The management system 1 manages a print order to the printing apparatus 300. The print order corresponds to a request or an order for printing. The management system 1 may manage a processing status in the printing apparatus 300. The management system 1 may manage a history of print jobs executed in the printing apparatus 300.

The printing apparatus 300 is an apparatus that performs printing, such as a printer. The printing apparatus 300 functions as an image forming apparatus. The printing apparatus 300 may have a function serving as a computer. The printing apparatus 300 receives a print job and executes print processing concerning the print job. Accordingly, the printing apparatus 300 performs printing. The print job corresponds to a print instruction generated by, for example, operation of a user. The print job can include print data that is data of print processing to be executed. The print data is data indicating a job image to be printed on a print medium such as paper. Therefore, the print job includes a job image. The print data is, for example, document editing file data or image display file data. The job image is a printing target image. Hereinafter, the term “image” also means “image data indicating an image” serving as a processing target in information processing.

The printing apparatus 300 is considered to be an apparatus that executes a job for a printing target file. The job corresponds to an instruction to execute some processing on a job file. The job file is a processing target file. When the job is a print job, the job file is a file indicating a job image.

The information processing terminal 100 is a computer including a processor and a memory. The information processing terminal 100 is a computer such as a personal computer (PC). The information processing terminal 100 may be a mobile terminal such as a smartphone or a tablet terminal. The information processing terminal 100 is operated by the user. The user performs color adjustment, processing, editing, print setting, and the like for a job image using the functions of the information processing terminal 100. The user sets printing of the job image and requests the printing of the job image using the functions of the information processing terminal 100. The information processing terminal 100 transmits a print request for the job image to the server 200. The print request for the job image corresponds to the print job explained above. Details of the information processing terminal 100 are explained below.

The server 200 is a computer including a processor and a memory. Therefore, the server 200 is an information processing apparatus having a function serving as a computer. The server 200 may be implemented by, for example, cloud computing. In this case, the server 200 may be a cloud server. The server 200 may be implemented by a plurality of computers. The server 200 includes a Web application that provides a Web service. Therefore, the server 200 functions as a Web server. The server 200 provides a Web service to the user of the information processing terminal 100 by executing a Web application.

The server 200 may provide, for example, a print service that performs processing concerning printing for a job image in response to a request from the user of the information processing terminal 100. In this case, the server 200 includes a print Web application that provides a print service. For example, the print Web application may provide a remote print service that causes the printing apparatus 300, which is provided in a place away from the position of the information processing terminal 100, to execute printing of the job image requested from the user of the information processing terminal 100. The server 200 transmits a print job corresponding to the request for printing of the job image to the printing apparatus 300. Accordingly, the printing apparatus 300 executes printing of the job image concerning the print job. The details of the server 200 are explained below.

The terminal apparatus 4 is a computer including a processor and a memory. The terminal apparatus 4 is, for example, a computer such as a PC. The terminal apparatus 4 displays information concerning a service provided by the Web application of the server 200 in a viewable manner. For example, the terminal apparatus 4 may display information concerning a print job in a viewable manner. The terminal apparatus 4 may be a terminal of a printing operator who gives a print instruction. The terminal apparatus 4 can have a hardware configuration of the information processing terminal 100 explained below.

The information processing terminal 100 includes a native application for performing color adjustment, processing, editing, print setting, and the like for a job image. The native application is installed in the information processing terminal 100 and operates in the information processing terminal 100. The native application may be, for example, raster image processor (RIP) software. The information processing terminal 100 may use a Web browser to access a Web service provided by a Web application of the server 200. The information processing terminal 100 may include an internal browser that cooperates with the native application. The internal browser can be used when accessing the Web service while the native application is being executed. The internal browser can also be referred to as “in-application browser”. The internal browser includes, for example, WebView or WebView 2 but is not limited thereto.

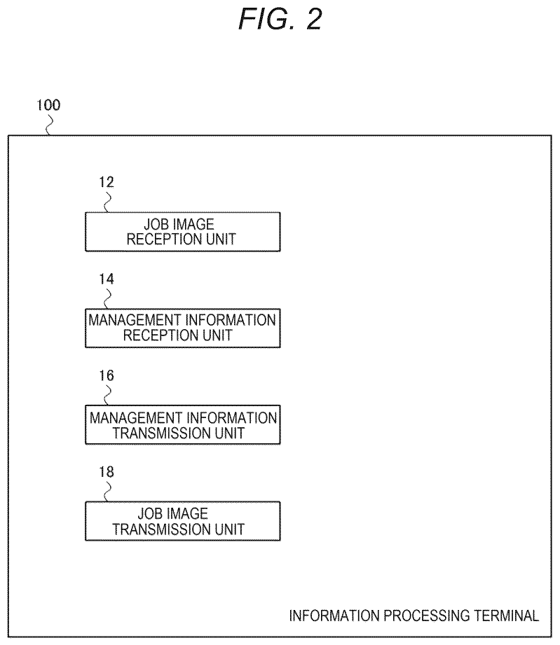

FIG. 2 is a diagram illustrating an overview of the information processing terminal 100 according to the present embodiment. The information processing terminal 100 includes a job image reception unit 12, a management information reception unit 14, a management information transmission unit 16, and a job image transmission unit 18 as elements. These elements are implemented by causing the computer of the information processing terminal 100 to execute a program. Functions of these elements are explained below.

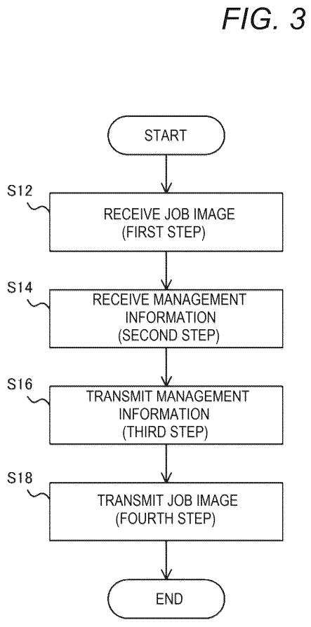

FIG. 3 is a flowchart illustrating a transmission method according to the present embodiment. FIG. 3 illustrates an overview of processing executed by the management system 1 according to the present embodiment. The processing illustrated in FIG. 3 is mainly executed by the information processing terminal 100 illustrated in FIG. 2. Details of processing of steps illustrated in FIG. 3 are explained in a first embodiment and a second embodiment explained below.

The information processing terminal 100 executes a first step of receiving a job image (step S12). Specifically, the job image reception unit 12 uses a function of the native application to receive designation of a job image, which is a printing target image. The job image reception unit 12 receives designation of a job image according to, for example, operation of the user.

The information processing terminal 100 executes a second step of receiving management information (step S14). Specifically, the management information reception unit 14 displays a Web application screen using a function of an internal browser that cooperates with the native application. The Web application screen is an operation screen, that is, an operation window of a Web application provided in the server 200, which is the print server. The management information reception unit 14 receives, on the Web application screen, input of management information used for management of the job image for which the designation is received in the processing in S12. The management information is information concerning printing for the job image. Details of the management information are explained below.

The information processing terminal 100 executes a third step of transmitting the management information (step S16). Specifically, the management information transmission unit 16 transmits the management information, the input of which is received using the function of the internal browser in the processing of S14, to the server 200, which is the printing server.

The information processing terminal 100 executes a fourth step of transmitting the job image (step S18). Specifically, the job image transmission unit 18 transmits the job image, the designation of which is received in the processing in S12 to the server 200, which is the print server, using the function of the native application without using the function of the internal browser. As explained below, the server 200 instructs, using the job image and the management information transmitted from the information processing terminal 100, the printing apparatus 300 to perform printing.

As explained in the first embodiment explained below, in the third step, the management information transmission unit 16 may transmit the management information, the input of which is received using the function of the internal browser, to the server 200 using the function of the native application. As explained in the first embodiment explained below, the information processing terminal 100 may collectively transmit the management information and the job image to the print server using the function of the native application in the third step and the fourth step. In this case, the management information transmission unit 16 and the job image transmission unit 18 may be an integral element.

As explained in the second embodiment explained below, in the third step, the management information transmission unit 16 may transmit the management information, the input of which is received using the function of the internal browser, to the server 200 using the function of the internal browser without using the function of the native application. As explained in the second embodiment explained below, the information processing terminal 100 may transmit the management information and the job image to the server 200 at different timings in the third step and the fourth step. As explained in the second embodiment explained below, the management system 1 may assign identification information to the management information at a timing before the fourth step and transmit the identification information to the server 200 together with the job image in the fourth step. In this case, the server 200 may assign the identification information to the management information or the information processing terminal 100 may assign the identification information to the management information.

The job image designated in the first step may be an image stored in the information processing terminal 100 in which the native application operates. That is, the job image may be stored in a local folder of the information processing terminal 100. However, the job image may not be stored in the local folder of the information processing terminal 100. The job image may be stored in an apparatus communicably connected to the information processing terminal 100 via a local area network (LAN), an external memory connectable to the information processing terminal 100, a cloud server different from the server 200, or the like.

In the first step, the information processing terminal 100 may receive a print condition for the job image in addition to the designation of the job image using the function of the native application. In the fourth step, the job image transmission unit 18 may transmit the print condition to the server 200 together with the job image. The print conditions transmitted to the server 200 may be indicated in a JDF file created in a JDF (Job Definition Format) format. Details of the print condition are explained below.

Here, it is conceived that the user of the information processing terminal 100 performs print setting for the job image using the native application and subsequently performs print request for the Web service to the job image. First, when performing print setting or the like for the job image using the native application, the user designates a file concerning the job image with the function of the native application. The designated job image is stored in, for example, a local folder of the information processing terminal 100. In this case, the user designates a path of the local folder in which the job image is stored. Subsequently, the user of the information processing terminal 100 inputs management information concerning the job image using the Web application screen concerning the Web service displayed by the browser.

On the other hand, it is conceived that the information processing terminal 100 uploads the print job of the job image to the Web application of the server 200 using the Web browser when the information processing terminal 100 does not include the elements according to the present embodiment explained above with reference to FIGS. 2 and 3. Here, from the viewpoint of security, a Web application using a general Web browser has specifications that disables a file from being automatically uploaded from a storage other than the server 200, such as the local folder of the information processing terminal 100. Therefore, the general Web browser sometimes cannot access the path designated by the native application without operation of the user.

Therefore, the user can need to designate, again, in the Web browser, the file concerning the job image designated using the function of the native application. The same applies when the print job of the job image is uploaded to the Web application of the server 200 using the internal browser that cooperates with the native application. That is, the user can need to designate, again, in the internal browser, the file concerning the job image designated using the function of the native application. As explained above, the user can need to designate the file concerning the job image again in the browser such as the Web browser and the internal browser. Therefore, since the user needs to designate the job image twice, the user is likely to feel that the operation is complicated. Therefore, the convenience of the user is likely to be impaired.

On the other hand, the information processing terminal 100 according to the present embodiment is configured to transmit the job image designated using the native application to the server 200 using the function of the native application rather than the internal browser. Therefore, if the user designates a job image with the native application, the user can upload a print job concerning the job image without designating the job image thereafter. Therefore, in the present embodiment, when the job image, which is the printing target image, is transmitted to the server that provides the Web application, it is possible to simplify operation of the user. In other words, when a processing target job file is transmitted to the server that provides the Web application, it is possible to simplify operation of the user.

### First Embodiment

Subsequently, a first embodiment is explained with reference to the drawings. To clarify the explanation, the following description and the drawings are omitted or simplified as appropriate. In the drawings, the same elements are denoted by the same reference numerals and signs and redundant explanation of the elements is omitted according to necessity. Since the configuration of the management system 1 according to the first embodiment is substantially the same as the configuration illustrated in FIG. 1 explained above, explanation of the configuration is omitted.

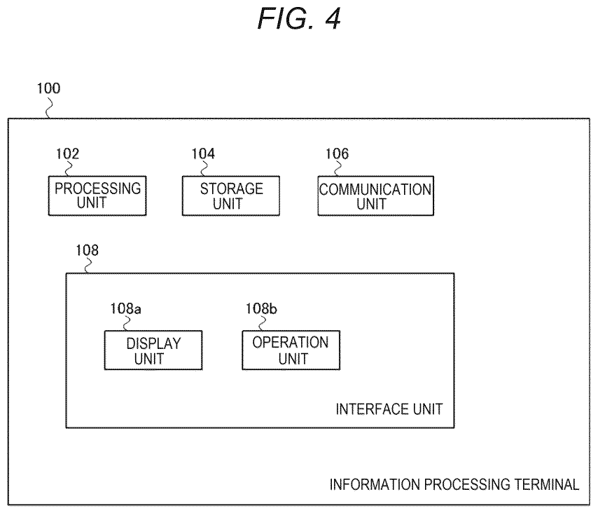

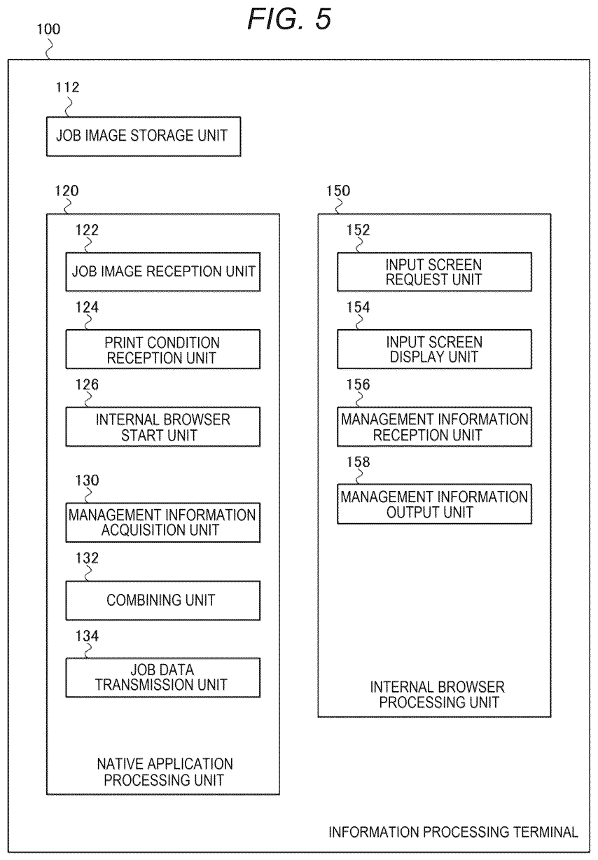

FIGS. 4 and 5 are diagrams illustrating a configuration of the information processing terminal 100 according to the first embodiment. FIG. 4 is a diagram illustrating a hardware configuration of the information processing terminal 100. The information processing terminal 100 according to the first embodiment includes a processing unit 102, a storage unit 104, a communication unit 106, and an interface unit 108 as main hardware components. The processing unit 102, the storage unit 104, the communication unit 106, and the interface unit 108 may be connected to one another via a data bus or the like.

The processing unit 102 is a processor such as a central processing unit (CPU). The processing unit 102 may include a plurality of processors. The processing unit 102 has a function serving as an arithmetic device that performs control processing, arithmetic processing, and the like. The processing unit 102 controls the storage unit 104, the communication unit 106, and the interface unit 108.

The storage unit 104 is a storage device such as a memory or a hard disk. The storage unit 104 is, for example, a ROM (Read-Only Memory) or a RAM (Random Access Memory). The storage unit 104 may include a plurality of memories. The storage unit 104 has a function for storing a control program, an arithmetic program, and the like to be executed by the processing unit 102. The storage unit 104 has a function for temporarily storing processing data and the like. The storage unit 104 can include a database.

The communication unit 106 performs processing necessary for the information processing terminal 100 to communicate with another apparatus via a network. The communication unit 106 can include a communication port, a router, and a firewall. The communication unit 106 performs processing for the information processing terminal 100 to communicate with the server 200. The communication unit 106 may perform processing for the information processing terminal 100 to communicate with the printing apparatus 300 or the terminal apparatus 4.

The interface unit 108 is, for example, a user interface. The interface unit 108 receives operation of inputting data by the user of the information processing terminal 100 and outputs information to the user. The interface unit 108 includes a display unit 108a and an operation unit 108b. The display unit 108a is a display device that displays an image, such as a display. The display unit 108a is an output device that outputs information. The operation unit 108b is an input device for inputting or selecting information, such as a keyboard or a mouse. The operation unit 108b is an input device for inputting information. The interface unit 108 may be configured such that the input device and the output device are integrated like, for example, a touch screen or a touch panel. In this case, the display unit 108a and the operation unit 108b may be physically integrated. The interface unit 108 may include a speaker and a microphone.

FIG. 5 is a diagram illustrating elements of the information processing terminal 100 according to the first embodiment. The information processing terminal 100 according to the first embodiment includes a job image storage unit 112, a native application processing unit 120, and an internal browser processing unit 150 as elements. The native application processing unit 120 includes a job image reception unit 122, a print condition reception unit 124, an internal browser start unit 126, a management information acquisition unit 130, a combining unit 132, and a job data transmission unit 134. The internal browser processing unit 150 includes an input screen request unit 152, an input screen display unit 154, a management information reception unit 156, and a management information output unit 158. These elements can operate according to an operating system, which is basic software.

The elements explained above can be implemented by, for example, executing a program according to the control of the processing unit 102. More specifically, the elements can be implemented by the processing unit 102 executing programs stored in the storage unit 104. The elements may be implemented by recording necessary programs in any nonvolatile recording medium and installing the programs according to necessity. This is the same in another embodiment explained below.

The elements are not limited to be implemented by software by the programs and may be implemented by, for example, a combination any one of hardware, firmware, and software. The elements may be implemented using an integrated circuit that can be programmed by a user, such as a field-programmable gate array (FPGA) or a microcomputer. In this case, a program including the elements explained above may be implemented using the integrated circuit. This is the same in another embodiment explained below.

The job image storage unit 112 stores a job image. The job image storage unit 112 can be implemented by the storage unit 104. That is, the job image storage unit 112 stores an image file indicating the job image in the local folder of the information processing terminal 100. As explained above, the job image may not be stored in the local folder of the information processing terminal 100.

The native application processing unit 120 is implemented by a native application. The native application is installed in the information processing terminal 100 and operates in the information processing terminal 100. The native application may be software for performing print setting and the like, such as RIP software. The native application processing unit 120 implements the function of the native application. The native application processing unit 120 causes the interface unit 108 to display a native application screen. The native application screen is an operation screen, that is, an operation window of the native application. The native application screen can be implemented by a graphical user interface (GUI). An example of the native application screen is explained below.

The native application processing unit 120 receives operation of the user performed on the native application screen and executes an operation corresponding to the operation. For example, the native application processing unit 120 may receive designation of a processing target job image according to operation of the user. The native application processing unit 120 may perform color adjustment for the job image according to operation of the user. Further, for example, the native application processing unit 120 may perform print setting of a job image according to operation of the user. For example, the native application processing unit 120 may edit the job image according to operation of the user.

The internal browser processing unit 150 is implemented by an internal browser that cooperates with the native application implemented by the native application processing unit 120. The internal browser may be implemented by the function of the native application. The internal browser processing unit 150 implements the function of the internal browser. The internal browser processing unit 150 can operate according to a function of the Web application implemented by the server 200. The internal browser processing unit 150 causes the interface unit 108 to display a Web application screen provided from the server 200. The Web application screen can be implemented by a GUI. An example of the Web application screen is explained below. The internal browser processing unit 150 receives operation of the user performed on the Web application screen and executes an operation corresponding to the operation. For example, the internal browser processing unit 150 may receive input of management information concerning the job image according to operation of the user.

The job image reception unit 122 corresponds to the job image reception unit 12 illustrated in FIG. 2 explained above. Therefore, processing of the job image reception unit 122 corresponds to the first step explained above. The job image reception unit 122 receives designation of a job image, which is a printing target image. Here, the job image reception unit 122 is implemented using the function of the native application. Therefore, the information processing terminal 100 receives the designation of the job image using the function of the native application.

The job image reception unit 122 may receive designation of a job image stored by the job image storage unit 112, for example, according to operation of the user on the native application screen displayed on the interface unit 108. Therefore, the job image designated by the job image reception unit 122 may be an image stored in the information processing terminal 100 on which the native application operates.

For example, the job image reception unit 122 may cause, for example, according to operation of the user, the interface unit 108 to display a dialogue box indicating a path of a folder in which the job image is stored. Then, the user selects an image file indicating the job image using the displayed dialogue box, whereby the job image reception unit 122 may receive the designation of the job image. The job image reception unit 122 may receive designation of a plurality of job images.

The print condition reception unit 124 receives a print condition for the job image according to operation of the user. The processing of the print condition reception unit 124 may be included in the first step explained above. Specifically, the print condition reception unit 124 receives the print condition for the job image in response to operation of the user on the native application screen displayed on the interface unit 108. The print condition corresponds to print setting concerning printing of the job image executed by the printing apparatus 300. Therefore, the print condition reception unit 124 performs the print setting for the job image according to operation of the user. Here, the print condition reception unit 124 receives the print condition for the job image using the function of the native application. Therefore, the information processing terminal 100 receives the print condition for the job image in addition to the designation of the job image using the function of the native application. Accordingly, the print condition reception unit 124 performs the print setting and generates print condition data indicating the print condition. The print condition data may be, for example, the JDF file explained above. The print condition data may be added to the job image.

The print settings may include, for example, basic setting, layout setting, color setting, and print range setting. The basic setting may include, for example, medium size setting, print quality setting, and margin setting. The layout setting may include, for example, print number of copies setting, position adjustment setting, enlargement and reduction setting, rotation setting, and centering setting. When a plurality of job images are designated, the layout setting may include arrangement setting of the plurality of job images to be printed on a medium.

The internal browser start unit 126 starts the internal browser according to operation of the user. The internal browser start unit 126 starts the internal browser according to operation of the user when a print job concerning the job image designated and subjected to the print setting as explained above is uploaded to the server 200. For example, the internal browser start unit 126 may start the internal browser according to a button provided in the native application screen being pressed by operation of the user. This button may be a job upload button for uploading the print job for the job image designated by the function of the native application. When the internal browser start unit 126 starts the internal browser, processing of the internal browser processing unit 150 explained below is executed.

The input screen request unit 152 requests the server 200 to transmit an input screen. The input screen request unit 152 may be implemented by the communication unit 106. Specifically, when the internal browser is started by the internal browser start unit 126, the input screen request unit 152 transmits, to the server 200, a screen request instruction for requesting the server 200 to transmit the input screen, which is a Web application screen. The screen request instruction includes an address of the Web application screen such as a uniform resource locator (URL). As is explained below, when receiving the screen request instruction, the server 200 transmits the Web application screen corresponding to the address included in the screen request instruction to the information processing terminal 100 as a response. The input screen request unit 152 receives the input screen transmitted from the server 200 in response to the screen request instruction. The address included in the screen request instruction may be determined in advance. Therefore, the Web application screen received from server 200 and displayed using the function of the internal browser may be determined in advance.

The input screen display unit 154 corresponds to the management information reception unit 14 illustrated in FIG. 2 explained above. Therefore, the processing of the input screen display unit 154 corresponds to the second step explained above. The input screen display unit 154 causes the interface unit 108 to display the input screen transmitted from the server 200. The input screen is a Web application screen for the user to input management information. The input screen can be implemented by a GUI. The input screen display unit 154 displays the input screen using the function of the internal browser. Therefore, the input screen display unit 154 displays a Web application screen, which is a screen of the Web application provided in the server 200, using the function of the internal browser.

The management information reception unit 156 corresponds to the management information reception unit 14 illustrated in FIG. 2 explained above. Therefore, the processing of the management information reception unit 156 corresponds to the second step explained above. The management information reception unit 156 receives input of management information using the function of the internal browser. Specifically, the management information reception unit 156 receives, according to operation by the user on the input screen, which is the Web application screen, the management information concerning the job image designated by the job image reception unit 122. That is, the user inputs the management information concerning the job image to the input screen implemented by the GUI. Accordingly, the management information reception unit 156 receives the management information used for management of the job image on the Web application screen using the function of the internal browser. Accordingly, the management information reception unit 156 generates the management information.

The management information is information used for management the job image selected by the job image reception unit 122 of the native application when the internal browser is started by the internal browser start unit 126 of the native application. The management information is used when the server 200 requests the printing apparatus 300 to print the job image. The management information may be, for example, text data. The management information is information concerning an order of printing of the job image.

The management information includes at least one of an order name, an order number, a job name, the number of deliveries, a customer name, a relative priority level, and a delivery date concerning the printing of the job image. The order name is a character string for identifying an order of printing concerning a print job concerning the job image. The order number is a number for identifying the order of the printing concerning the print job concerning the job image. The order number may be a serial number. The job name is a character string for identifying the print job concerning the job image. The job name may be a file name of a file corresponding to the job image. The number of deliveries is the number of prints delivered in the order of the printing corresponding to the management information. The customer name is a delivery destination of the print delivered in the order of the printing corresponding to the management information. The relative priority level corresponds to a priority level of the order of the printing corresponding to the management information. The priority level may be, for example, urgency. The delivery date is a delivery deadline of the print printed in the order of the printing corresponding to the management information.

The management information output unit 158 outputs the management information, the input of which has been received using the function of the internal browser, to the native application according to operation of the user. When uploading, to the server 200, the print job concerning the job image corresponding to the management information input as explained above, the management information output unit 158 outputs the management information to the native application according to operation of the user. For example, the Web application screen may include a button for uploading the print job to server 200. Then, the management information output unit 158 may output the management information to the native application in response to the button being pressed by operation of the user.

The management information acquisition unit 130 acquires the management information output by the management information output unit 158. Processing of the combining unit 132 and the job data transmission unit 134 explained below is executed in response to the management information acquisition unit 130 acquiring the management information. That is, when the management information is output to the native application according to operation of the user, the processing of the management information acquisition unit 130, the combining unit 132, and the job data transmission unit 134 is executed without the user performing operation. Therefore, when the user presses the button for upload provided in the Web application screen, the processing of the management information acquisition unit 130, the combining unit 132, and the job data transmission unit 134 is automatically executed.

The combining unit 132 combines the job image and the acquired management information. Specifically, the combining unit 132 combines the job image selected by the job image reception unit 122 and subjected to the print setting by the print condition reception unit 124 with the management information output from the internal browser. Accordingly, the combining unit 132 generates job data obtained by combining the job image and the management information. That is, in the first embodiment, the job data is data in which the job image and the management information concerning the job image are collected. The job data corresponds to the print job concerning the job image. As explained above, the print condition data indicating the print condition set by the print condition reception unit 124 is added to the job image included in the job data. Therefore, the combining unit 132 generates job data including the job image, the print condition data, and the management information. For example, the job data may be a compressed file generated by compressing the job image, the print condition data, and the management information.

A job data transmission unit 134 performs processing for transmitting the job data to the server 200. The job data transmission unit 134 may be implemented by, for example, the communication unit 106. The job data transmission unit 134 may control the communication unit 106 to transmit the job data to the server 200.

As explained above, in the first embodiment, the job data includes the management information. Therefore, in the first embodiment, the job data transmission unit 134 transmits the management information input using the function of the internal browser to the server 200. Therefore, in the first embodiment, the job data transmission unit 134 corresponds to the management information transmission unit 16 illustrated in FIG. 2 explained above. Therefore, in the first embodiment, the processing of the job data transmission unit 134 corresponds to the third step explained above. The job data transmission unit 134 is implemented using the function of the native application. Therefore, the job data transmission unit 134 transmits the management information, the input has been received using the function of the internal browser, to the server 200 by using the function of the native application. That is, the information processing terminal 100 transmits the management information, the input of which has been received using the function of the internal browser, from the internal browser to the server 200 through the native application.

As explained above, the job data includes the job image. Therefore, the job data transmission unit 134 corresponds to the job image transmission unit 18 illustrated in FIG. 2 explained above. Therefore, the processing of the job data transmission unit 134 corresponds to the fourth step explained above. The job data transmission unit 134 is implemented using the function of the native application. That is, the job data transmission unit 134 is not implemented by the function of the internal browser. Therefore, the job data transmission unit 134 transmits the job image to the server 200 using the function of the native application without using the function of the internal browser. In other words, the job data transmission unit 134 transmits the job image from the native application to the server 200 without using the internal browser.

As explained above, in the first embodiment, the job data includes the job image and the management information. Therefore, in the first embodiment, the job data transmission unit 134 collectively transmits the job image and the management information to the server 200 using the function of the native application in the third step and the fourth step explained above. As explained above, the print condition is added to the job image. Therefore, the job data transmission unit 134 transmits the print condition to the server 200 together with the job image.

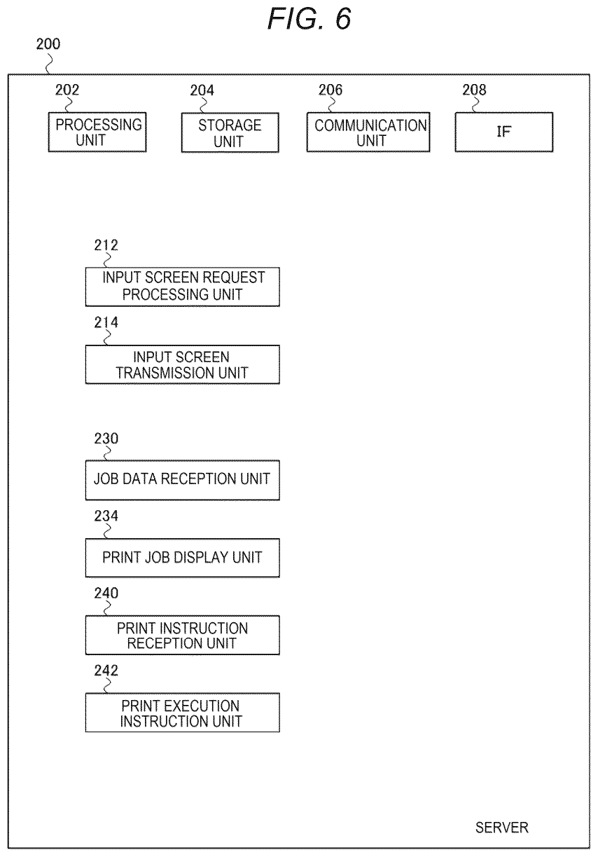

FIG. 6 is a diagram illustrating a configuration of the server 200 according to the first embodiment. The server 200 includes a processing unit 202, a storage unit 204, a communication unit 206, and an interface unit 208 as main hardware components. The processing unit 202, the storage unit 204, the communication unit 206, and the interface unit 208 may be connected to one another via a data bus or the like.

The processing unit 202 is a processor such as a CPU. The processing unit 202 may include a plurality of processors. The processing unit 202 has a function serving as an arithmetic device that performs control processing, arithmetic processing, and the like. The processing unit 202 controls the storage unit 204, the communication unit 206, and the interface unit 208.

The storage unit 204 is a storage device such as a memory or a hard disk. The storage unit 204 is, for example, a ROM or a RAM. The storage unit 204 may include a plurality of memories. The storage unit 204 has a function of storing a control program, an arithmetic program, and the like to be executed by the processing unit 202. The storage unit 204 has a function of temporarily storing processing data and the like. The storage unit 204 may include a database.

The communication unit 206 performs processing necessary for the server 200 to communicate with another apparatus via a network. The communication unit 206 can include a communication port, a router, a firewall, and the like. The communication unit 206 performs processing for the server 200 to communicate with the information processing terminal 100, the printing apparatus 300, or the terminal apparatus 4.

The interface unit 208 is, for example, a user interface. The interface unit 208 receives operation of inputting data by an operator, who is the user of the server 200, and outputs information to the operator. The interface unit 208 includes an input device such as a keyboard, a touch panel, or a mouse and an output device such as a display or a speaker. The interface unit 208 may be configured such that the input device and the output device are integrated like, for example, a touch screen or a touch panel. The interface unit 208 receives operation of inputting data by the operator and outputs information to the operator.

The server 200 according to the first embodiment includes, as elements, an input screen request processing unit 212, an input screen transmission unit 214, a job data reception unit 230, a print job display unit 234, a print instruction reception unit 240, and a print execution instruction unit 242. These elements can operate according to an operating system, which is basic software. The server 200 implements the function of the Web application with these elements. These elements function as a Web application processing unit that executes the Web application. The server 200 executes the Web application with these elements to provide a Web service to the user of the information processing terminal 100.

The elements explained above can be implemented by executing programs, for example, according to the control of the processing unit 202. More specifically, the elements can be implemented by the processing unit 202 executing the programs stored in the storage unit 204. The elements may be implemented by recording necessary programs in any nonvolatile recording medium and installing the programs according to necessity. This is the same in another embodiment explained below.

The elements are not limited to be implemented by software by the programs and may be implemented by, for example, a combination any one of hardware, firmware, and software. The elements may be implemented by using an integrated circuit that can be programmed by the user, such as an FPGA or a microcomputer. In this case, a program including the elements explained above may be implemented using the integrated circuit. This is the same in another embodiment explained below.

The input screen request processing unit 212 performs processing concerning the request for the input screen performed by the information processing terminal 100. Specifically, the input screen request processing unit 212 receives the request for the input screen from the information processing terminal 100. The input screen request processing unit 212 determines an input screen corresponding to the address indicated by the screen request instruction transmitted by the function of the internal browser of the information processing terminal 100 and extracts data indicating the input screen.

The input screen transmission unit 214 transmits the data indicating the input screen extracted by the input screen request processing unit 212 to the information processing terminal 100. The input screen transmission unit 214 may be implemented by the communication unit 206. The input screen transmission unit 214 may control the communication unit 206 to transmit the data indicating the input screen to the information processing terminal 100.

The job data reception unit 230 receives job data from the information processing terminal 100. The job data reception unit 230 may be implemented by, for example, the communication unit 206. The job data reception unit 230 receives the job image, the print condition added to the job image, and the management information included in the job data. Accordingly, the server 200 receives a print job.

The print job display unit 234 performs processing for displaying the print job. Specifically, the print job display unit 234 causes the interface unit 208 of the server 200 to display a Web application screen used by a printing operator. Then, the print job display unit 234 causes the Web application screen to display a list of one or more print jobs received from the information processing terminal 100. In other words, the print job display unit 234 causes the Web application screen to display a list of print jobs corresponding to the job data. Here, as explained below, the print job is transmitted to the printing apparatus 300 when the server 200 instructs the printing apparatus 300 to perform printing. The print job includes a job image, a print condition, and management information. The print job display unit 234 may cause the terminal apparatus 4 used by the printing operator to display the Web application screen used by the printing operator.

The print instruction reception unit 240 receives a print instruction. The print instruction is an instruction of printing by the printing operator. Specifically, the print instruction reception unit 240 may receive the print instruction according to operation of the printing operator on the Web application screen. By receiving operation of the printing operator on a Web application screen on which a list of a plurality of print jobs is displayed, the print instruction reception unit 240 may receive a print instruction for a print job to be printed. For example, the print instruction reception unit 240 may receive the print instruction by a button provided in the Web application screen being pressed by operation of the printing operator. The Web application screen may display a button for the print instruction near each of the displayed plurality of print jobs. By the button displayed on the Web application screen being pressed by operation of the printing operator, the print instruction reception unit 240 may receive a print instruction concerning a print job near the pressed button. The print instruction reception unit 240 may receive designation of the printing apparatus 300 that executes printing.

In response to the print instruction reception unit 240 receiving the print instruction, the print execution instruction unit 242 instructs the printing apparatus 300 to execute printing. Specifically, the print execution instruction unit 242 controls the communication unit 206 to perform processing for transmitting the instructed print job to the designated printing apparatus 300. Accordingly, the printing apparatus 300 executes printing according to the print job. Specifically, the printing apparatus 300 prints a job image included in the print job on a medium according to a print condition and management information included in the received print job.

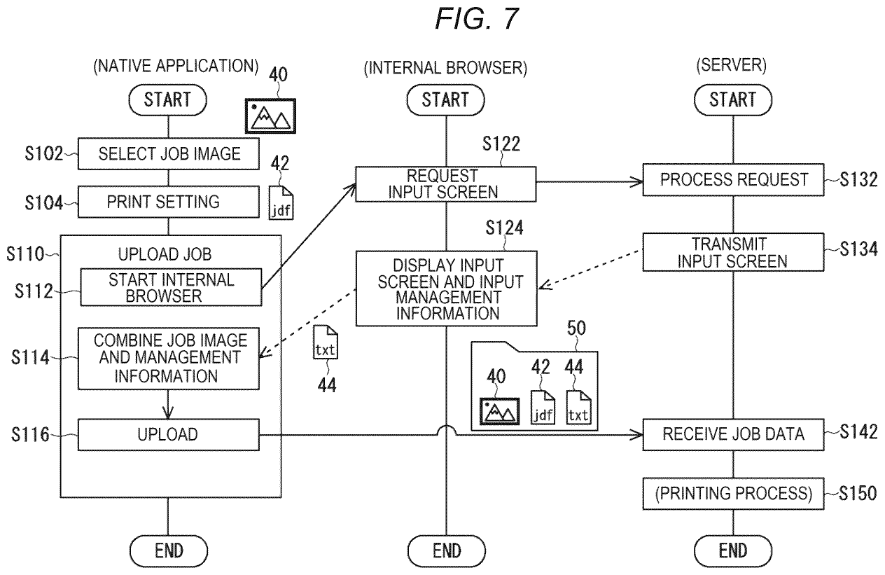

FIG. 7 is a sequence diagram illustrating processing to be executed by the management system 1 according to the first embodiment. The native application processing unit 120 of the information processing terminal 100 selects a printing target job image (step S102). This processing corresponds to the first step illustrated in FIG. 3 explained above. Specifically, as explained above, the job image reception unit 122 receives designation of a job image 40, which is a printing target image, according to operation of the user. Accordingly, the job image reception unit 122 selects the printing target job image 40.

The native application processing unit 120 of the information processing terminal 100 performs print setting for the job image (step S104). This processing corresponds to the first step illustrated in FIG. 3 explained above. Specifically, as explained above, the print condition reception unit 124 receives, according to operation of the user, a print condition for the job image selected in the processing in S102. Accordingly, the print condition reception unit 124 generates print condition data 42. The print condition data 42 is added to the job image 40.

The native application processing unit 120 of the information processing terminal 100 performs job upload processing for uploading a print job for the job image 40 selected in the processing in the S102 (step S110). First, the native application processing unit 120 starts an internal browser (step S112). Specifically, as explained above, the internal browser start unit 126 starts the internal browser according to operation of the user. For example, the internal browser start unit 126 may start the internal browser according to operation of the user on the job upload button on the native application screen.

The internal browser processing unit 150 of the information processing terminal 100 requests the server 200 to transmit an input screen (step S122). Specifically, as explained above, the input screen request unit 152 transmits, to the server 200, a screen request instruction for requesting the server 200 to transmit an input screen, which is a Web application screen, the screen request instruction including an address of the input screen. The server 200 performs processing concerning the request made by the information processing terminal 100 (step S132). Specifically, as explained above, the input screen request processing unit 212 determines the input screen corresponding to the address indicated by the screen request instruction and extracts data indicating the input screen. The server 200 transmits the input screen to the information processing terminal 100 (step S134). Specifically, as explained above, the input screen transmission unit 214 transmits data indicating the extracted input screen to the information processing terminal 100.

The internal browser processing unit 150 of the information processing terminal 100 displays the input screen and receives input of management information (step S124). This processing corresponds to the second step illustrated in FIG. 3 explained above. Specifically, as explained above, the input screen display unit 154 causes the interface unit 108 to display the input screen transmitted from the server 200. As explained above, the management information reception unit 156 receives input of management information according to operation of the user. Accordingly, the management information reception unit 156 generates management information 44. As explained above, the management information output unit 158 outputs the management information 44 to the native application according to operation of the user.

The native application processing unit 120 of the information processing terminal 100 combines the job image 40 and the management information 44 (step S114). Specifically, the management information acquisition unit 130 acquires the management information 44 output by the management information output unit 158. As explained above, the combining unit 132 combines the job image 40 and the management information 44 to generate job data 50. As explained above, the print condition data 42 is added to the job image 40. Therefore, the job data 50 includes the job image 40, the print condition data 42, and the management information 44.

The native application processing unit 120 of the information processing terminal 100 uploads the print job (step S116). This processing corresponds to the third step and the fourth step illustrated in FIG. 3 explained above. Specifically, the job data transmission unit 134 transmits the job data 50 including the job image 40, the print condition data 42, and the management information 44 to the server 200. Accordingly, the print job concerning the job image 40 is uploaded to the server 200 without using the function of the internal browser.

The server 200 receives the job data 50 (step S142). Specifically, as explained above, the job data reception unit 230 receives the job data 50 including the job image 40, the print condition data 42, and the management information 44 from the information processing terminal 100. Then, the server 200 executes a printing process concerning the print job corresponding to the job data 50 (step S150). Specifically, as explained above, by receiving operation of the printing operator on the Web application screen, the print instruction reception unit 240 receives a print instruction concerning the print job corresponding to the job data 50. The print execution instruction unit 242 transmits the instructed print job to the printing apparatus 300. Accordingly, the printing apparatus 300 performs printing for the transmitted print job.

Subsequently, an example of a screen of a GUI displayed on the apparatuses in the present embodiment is explained. The example of the screen explained below indicates a screen according to the first embodiment but is substantially the same in a second embodiment explained below.

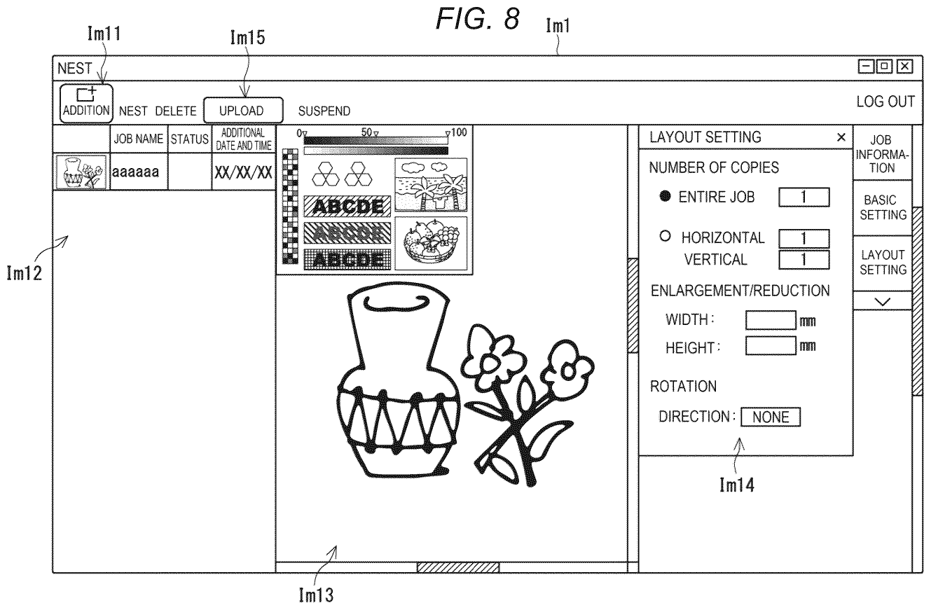

FIG. 8 is a diagram exemplifying a native application screen Im1 displayed on information processing terminal 100 in the present embodiment. The native application screen Im1 is a job setting screen in the native application. In the processing in S102 in FIG. 7, when a selection button Im11 of the native application screen Im1 is pressed by operation of the user, a selection screen for selecting, from the local folder, a job image that is an image desired to be printed is displayed. The selection screen may be, for example, a dialogue box. The user selects a file of the job image using the selection screen. The selected file of the job image is displayed in a job image file list region Im12. The selected job image is displayed in an image display region Im13. In the processing of S104, the user performs print setting concerning the job image displayed in the image display region Im13 using the print setting region Im14.

A job name is added to the file of the job image displayed in the job image file list region Im12. The job name may be input by the user or may be input in advance. When the job name is input in advance, the job name may be a file name of the job image. A job name for the file of the job image selected in the example illustrated in FIG. 8 is “aaaaaa”.

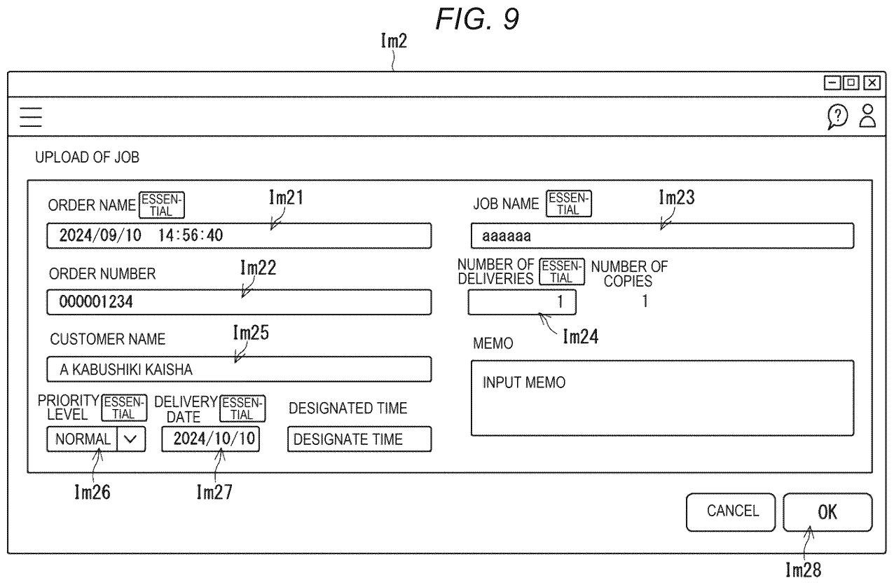

In the processing in S112, when an upload button Im15 is pressed by operation of the user, the internal browser starts in the information processing terminal 100. Then, a Web application screen exemplified in FIG. 9 explained below is displayed by the function of the internal browser. The Web application screen displayed by the function of the internal browser when the upload button Im15 is pressed is set in advance.

FIG. 9 is a diagram exemplifying a Web application screen Im2 displayed on information processing terminal 100 in the present embodiment. The Web application screen Im2 is displayed as being referred to as job upload screen for uploading a print job concerning a job image to the server 200. The Web application screen Im2 is an input screen for inputting management information concerning the job image. The Web application screen Im2 is acquired from the server 200 by the information processing terminal 100 requesting the server 200 to transmit the input screen in the processing in S122. In the processing in S124, the user performs operation on the Web application screen Im2 to input the management information concerning the job image. Here, the job image is the image selected in S102 using the native application screen Im1.

The Web application screen Im2 includes an order name input region Im21, an order number input region Im22, a job name input region Im23, a number-of-deliveries input region Im24, a customer name input region Im25, a priority level input region Im26, and a delivery date input region Im27. The user inputs an order name to the order name input region Im21. In the order name input region Im21, time when the upload button Im15 was pressed on the native application screen Im1 may be input in advance by default. In the order number input region Im22, an order number may be input in advance by the function of the Web application.

The user inputs a job name to the job name input region Im23. In the job name input region Im23, a job name displayed in the job image file list region Im12 and the image display region Im13 when the upload button Im15 is pressed on the native application screen Im1 may be input in advance by default. The user inputs the number of deliveries to the number-of-deliveries input region Im24. The user inputs a customer name to the customer name input region Im25. The user inputs a priority level to the priority level input region Im26. The user inputs a delivery date to the delivery date input region Im27.

Then, in the processing in S124, when the upload button Im28 is pressed by operation of the user, the management information input using the Web application screen Im2 is output. That is, when the upload button Im28 is pressed, the management information input using the internal browser is output. In the first embodiment, as explained above, the management information is output to the native application. In the processing in S114, the native application combines the management information with the job image selected using the native application screen Im1. In the processing in S116, the native application transmits job data including the job image and the management information to the server 200. Accordingly, the print job concerning the job image selected using the native application screen Im1 is uploaded to the server 200. As explained above, the print job concerning the job image selected using the native application screen Im1 is automatically uploaded to the server 200 without the job image being selected again by the user using the Web application screen Im2.

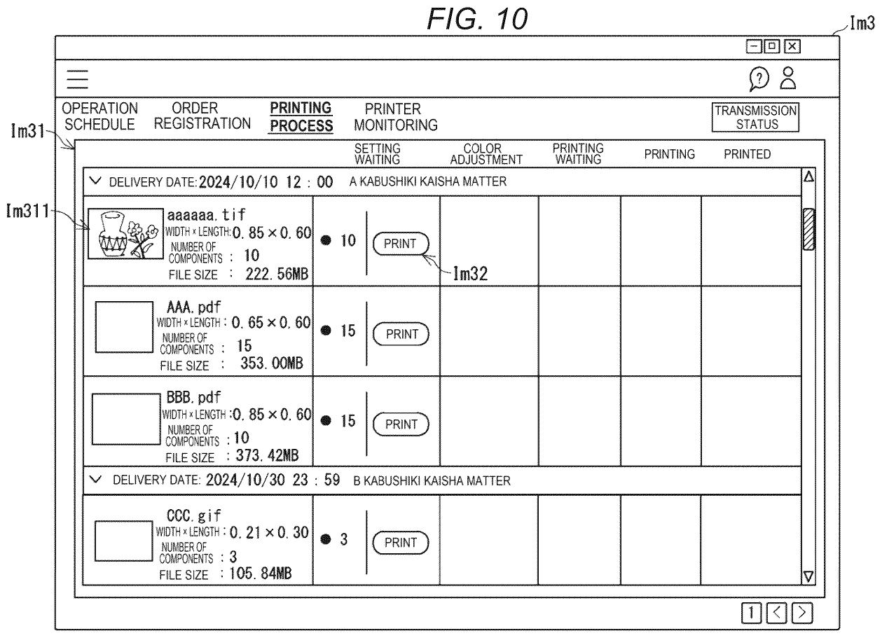

FIG. 10 is a diagram exemplifying a Web application screen Im3 displayed by the server 200 according to the present embodiment. The Web application screen Im3 is displayed by the print job display unit 234. In a list region Im31 of the Web application screen Im3, a list of print jobs uploaded by one or more information processing terminals 100 is displayed. In the list region Im31, as indicated by an arrow Im311, a print job concerning the job image selected on the native application screen Im1 exemplified in FIG. 8 is displayed.

Here, when the printing operator performs operation of pressing a print button Im32, as explained above, the print instruction reception unit 240 receives an instruction to print the print job indicated by the arrow Im311. At this time, the print instruction reception unit 240 displays, on the Web application screen Im3, a screen for selecting the printing apparatus 300 that executes printing. Then, the printing operator performs, using the screen, operation for selecting the printing apparatus 300 that executes printing. Then, the print execution instruction unit 242 transmits an instruction to print the print job indicated by the arrow Im311 to the printing apparatus 300 selected by the printing operator. Accordingly, the selected printing apparatus 300 executes printing of the print job indicated by the arrow Im311.

As explained above, in the first embodiment, the information processing terminal 100 transmits the job image to server 200 using the function of the native application rather than the function of the internal browser. With the configuration explained above, the user can upload the print job to the server 200 without performing operation of selecting the job image again after selecting the job image with the function of the native application and inputting the management information concerning the job image in the Web application. Therefore, the information processing terminal 100 according to the first embodiment is capable of simplifying operation of the user compared with a case of a comparative example explained below. That is, the information processing terminal 100 according to the first embodiment is capable of simplifying operation of the user compared with when it is necessary to perform the operation of selecting a job image again with the function of the internal browser. Therefore, in the first embodiment, the convenience of the user can be improved. This is the same in the second embodiment explained below.

### Comparative Example

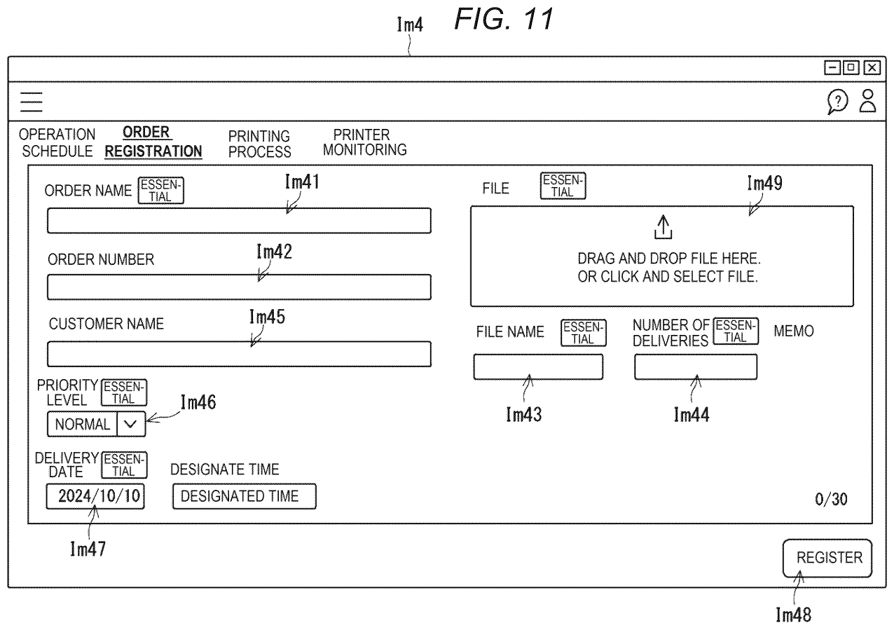

FIG. 11 is a diagram exemplifying a Web application screen Im4 displayed by the Web browser in the comparative example. The Web application screen Im4 is, for example, a job upload screen for uploading a print job concerning a job image selected using the function of the native application to the server 200. The Web application screen Im4 may be displayed by a Web browser different from the internal browser cooperating with the native application.

The Web application screen Im4 includes an order name input region Im41, an order number input region Im42, a file name input region Im43, a number-of-deliveries input region Im44, a customer name input region Im45, a priority level input region Im46, and a delivery date input region Im47. The user inputs management information concerning the job image selected using the function of the native application in substantially the same manner as the Web application screen Im2 exemplified in FIG. 9. In the file name input region Im43, a file name of a file selected using a file selection region Im49 explained below may be input.

Here, the Web application screen Im4 according to the comparative example includes the file selection region Im49. That is, as explained above, from the viewpoint of security, the Web application has specifications of not being able to automatically upload a file from the local folder of the information processing terminal 100. Therefore, in order to upload a job image using the Web application screen Im4, the file selection region Im49 for selecting a file of a job image, which is an image desired to be printed, is provided in the Web application screen Im4 according to the comparative example. By performing operation on the file selection region Im49, the user can select the file of the job image to be uploaded. For example, when the user performs operation of clicking the file selection region Im49, the selection screen for selecting a job image from the local folder is displayed again. The user selects a file of the job image again using the selection screen. Alternatively, the user may perform operation of dragging an icon of a file selected by the user from a file management screen by file management software to the file selection region Im49. When an upload button Im48 is pressed by operation of the user, the print job concerning the job image of the file selected using the file selection region Im49 is registered in the Web application.

Here, it is conceived that the user uploads a job image to the server 200 after performing print setting and the like concerning the job image using the function of the native application. In this case, the user has already selected, using the function of the native application, a file of the job image to be uploaded. In the comparative example, as explained above, the user has to select, again, using the Web application screen Im4, the file of the job image to be uploaded. Therefore, in the comparative example, the user has to select, a plurality of times, the file of the job image to be uploaded. This is the same when, in the comparative example, upload is performed using the internal browser that cooperates with the native application. That is, even when the management information is input using the internal browser that cooperates with the native application, the Web application screen Im4 as exemplified in FIG. 11 is displayed. Then, the user has to select the file of the job image again using the Web application screen Im4.

In contrast, in the first embodiment, as explained above, the user does not need to select a file of a job image using the internal browser after selecting, using the native application screen Im1, the file of the job image to be uploaded. Therefore, in the first embodiment, operation of the user can be simplified compared with the comparative example. This is the same in the second embodiment explained below. On the other hand, since the input screen for receiving the input of the management information is displayed using the internal browser, the native application itself does not need to include data for displaying the input screen. That is, if the display of the input screen is executed by the internal browser, cost for designing the native application can be reduced. The effect explained above is conspicuous, for example, when a function of uploading the same job image is imparted to a plurality of native applications having different providers.

### Second Embodiment

Subsequently, a second embodiment is explained with reference to the drawings. To clarify the explanation, the following description and the drawings are omitted or simplified as appropriate. In the drawings, the same elements are denoted by the same reference numerals and signs and redundant explanation of the elements is omitted according to necessity. Since a configuration of the management system 1 according to the second embodiment is substantially the same as the configuration illustrated in FIG. 1 explained above, explanation of the configuration is omitted. Since a hardware configuration of the information processing terminal 100 according to the second embodiment is substantially the same as the hardware configuration illustrated in FIG. 4 explained above, explanation of the hardware configuration is omitted.

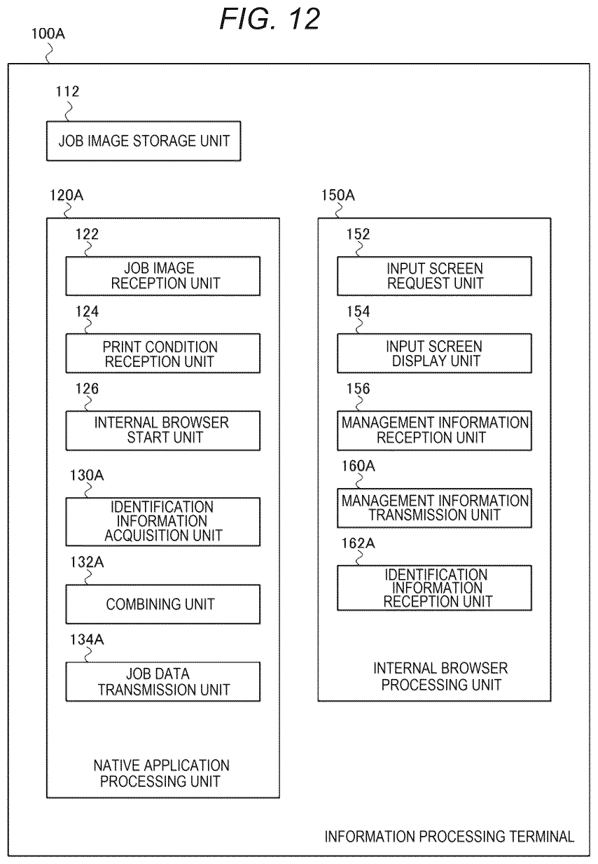

FIG. 12 is a diagram illustrating elements of the information processing terminal 100 according to the second embodiment. The information processing terminal 100 according to the second embodiment includes the job image storage unit 112, a native application processing unit 120A, and an internal browser processing unit 150A as elements. The native application processing unit 120A includes the job image reception unit 122, the print condition reception unit 124, the internal browser start unit 126, an identification information acquisition unit 130A, a combining unit 132A, and a job data transmission unit 134 A. The internal browser processing unit 150A includes the input screen request unit 152, the input screen display unit 154, the management information reception unit 156, a management information transmission unit 160A, and an identification information reception unit 162A. These elements can operate according to an operating system, which is basic software. In the information processing terminal 100 according to the second embodiment, since a function of the job image storage unit 112 is substantially the same as the function according to the first embodiment explained above, explanation of the function is omitted.

Like the native application processing unit 120 according to the first embodiment, the native application processing unit 120A is implemented by a native application. The native application processing unit 120A implements a function of the native application. The native application processing unit 120A causes the interface unit 108 to display the native application screen as exemplified in FIG. 8. The native application processing unit 120A receives operation of a user performed on the native application screen and executes an operation corresponding to the operation.

Like the internal browser processing unit 150 according to the first embodiment, the internal browser processing unit 150A is implemented by an internal browser that cooperates with the native application implemented by the native application processing unit 120A. The internal browser processing unit 150A implements a function of the internal browser. The internal browser processing unit 150A causes the interface unit 108 to display the Web application screen exemplified in FIG. 9. The internal browser processing unit 150A receives operation of the user performed on the Web application screen and executes an operation corresponding to the operation.

In the native application processing unit 120A, since operations of the job image reception unit 122, the print condition reception unit 124, and the internal browser start unit 126 are substantially the same as the operations according to the first embodiment explained above, explanation of the operations is omitted. In the internal browser processing unit 150A, since operations of the input screen request unit 152, the input screen display unit 154, and the management information reception unit 156 are substantially the same as the operations according to the first embodiment explained above, explanation of the operations is omitted.

The management information transmission unit 160A corresponds to the management information transmission unit 16 illustrated in FIG. 2 explained above. Therefore, processing of the management information transmission unit 160A corresponds to the third step explained above. The management information transmission unit 160A performs, according to operation of the user, processing for transmitting, to the server 200, management information, input of which has been received using the function of the internal browser. When a print job concerning a job image corresponding to the management information input as explained above is uploaded to server 200, the management information transmission unit 160A performs, according to operation of the user, processing for transmitting the management information to server 200. Here, the management information transmission unit 160A is implemented using the function of the internal browser. Therefore, unlike the first embodiment, the information processing terminal 100 according to the second embodiment transmits the management information, the input of which has been received using the function of the internal browser, to the server 200 using the function of the internal browser without using the function of the native application. The management information is not information stored in the local folder of the information processing terminal 100 but information input by a Web application using the function of the internal browser. Therefore, in the specifications of the Web application, the information processing terminal 100 is capable of transmitting the management information to the server 200 with the function of the internal browser.

The management information transmission unit 160A may be implemented by, for example, the communication unit 106. The management information transmission unit 160A may control the communication unit 106 to transmit the management information to the server 200. For example, the Web application screen may include a button for uploading the print job to server 200. The management information transmission unit 160A may transmit the management information to the server 200 according to the button being pressed by operation of the user.

As is explained below, in the second embodiment, the server 200 assigns identification information (ID: Identifier) to the management information received from information processing terminal 100. The identification information is information for identifying the management information. The identification information is explained in detail below.

The identification information reception unit 162A receives the identification information from the server 200. The identification information reception unit 162A may be implemented by, for example, the communication unit 106. The identification information reception unit 162A may control the communication unit 106 to receive the identification information for identifying the management information from the server 200. The identification information may be information that the user cannot visually recognize. Therefore, the identification information may not be displayed on the screen displayed using the function of the native application or the function of the internal browser. The identification information reception unit 162A outputs the identification information received from the server 200 to the native application processing unit 120A.

The identification information acquisition unit 130A acquires, from the internal browser processing unit 150A, the identification information of the management information input using the function of the internal browser. Processing of the combining unit 132A and the job data transmission unit 134A explained below is executed according to the identification information acquisition unit 130A acquiring the identification information of the management information. That is, when the management information is transmitted to the server 200 according to operation of the user, processing of the identification information acquisition unit 130A, the combining unit 132A, and the job data transmission unit 134A is executed without the user performing operation. Therefore, when the user presses a button for upload provided in the Web application screen, the processing of the identification information acquisition unit 130A, the combining unit 132A, and the job data transmission unit 134A is automatically executed.

The combining unit 132A combines the job image and the acquired identification information. Specifically, the combining unit 132A combines the job image selected by the job image reception unit 122 and subjected to the print setting by the print condition reception unit 124 with the identification information output from the internal browser. Accordingly, the combining unit 132A generates job data obtained by combining the job image and the identification information. That is, in the second embodiment, the job data is data in which the job image and the identification information of the management information concerning the job image are collected. The job data corresponds to the print job concerning the job image. As explained above, the print condition data indicating the print condition set by the print condition reception unit 124 is added to the job image included in the job data. Therefore, the combining unit 132A generates job data including the job image, the print condition data, and the identification information of the management information. The job data may be a compressed file generated by compressing the job image, the print condition data, and the identification information of the management information. Note that the job data according to the second embodiment does not include the management information itself.

A job data transmission unit 134A performs processing for transmitting the job data to the server 200. The job data transmission unit 134A may be implemented by, for example, the communication unit 106. The job data transmission unit 134A may control the communication unit 106 to transmit the job data to the server 200.

Here, as explained above, the job data includes the job image. Therefore, the job data transmission unit 134A corresponds to the job image transmission unit 18 illustrated in FIG. 2 explained above. Therefore, the processing of the job data transmission unit 134A corresponds to the fourth step explained above. The job data transmission unit 134A is implemented using the function of the native application. That is, the job data transmission unit 134A is not implemented by the function of the internal browser. Therefore, the job data transmission unit 134A transmits the job image to the server 200 using the function of the native application without using the function of the internal browser. In other words, the job data transmission unit 134A transmits the job image from the native application to the server 200 without using the internal browser.

As explained above, in the second embodiment, the job data does not include the management information. As explained above, the management information is transmitted to the server 200 by the management information transmission unit 160A implemented using the function of the internal browser. Therefore, the information processing terminal 100 according to the second embodiment individually transmits the job image and the management information to the server 200 at different timings in the third step and the fourth step explained above. That is, the information processing terminal 100 transmits the management information to the server 200 in the third step and thereafter transmits the job image to the server 200 in the fourth step. As explained above, the print condition is added to the job image. Therefore, the job data transmission unit 134A transmits the print condition to the server 200 together with the job image.

In the second embodiment, the identification information is assigned to the management information at a timing before the fourth step in which the job data transmission unit 134A transmits the job image. As explained above, in the second embodiment, the job data includes the job image and the identification information of the management information. Therefore, in the second embodiment, in the fourth step, the job data transmission unit 134A transmits the identification information to server 200 together with the job image.

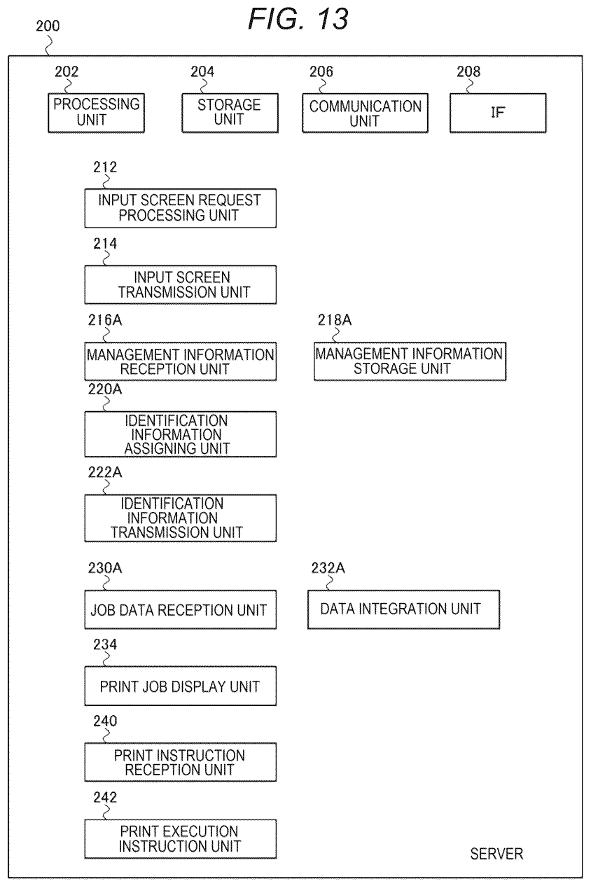

FIG. 13 is a diagram illustrating a configuration of the server 200 according to the second embodiment. Like the server 200 according to the first embodiment, the server 200 according to the second embodiment includes a processing unit 202, a storage unit 204, a communication unit 206, and an interface unit 208 as main hardware components. Since the processing unit 202, the storage unit 204, the communication unit 206, and the interface unit 208 are substantially the same as the units according to the first embodiment, explanation of the units is omitted.

The server 200 according to the second embodiment includes, as elements, the input screen request processing unit 212, the input screen transmission unit 214, a management information reception unit 216A, a management information storage unit 218A, an identification information assigning unit 220A, and an identification information transmission unit 222A. The server 200 according to the second embodiment includes, as elements, a job data reception unit 230A, a data integration unit 232A, the print job display unit 234, the print instruction reception unit 240, and the print execution instruction unit 242. These elements can operate according to an operating system, which is basic software.

The server 200 implements the function of the Web application with these elements. These elements function as a Web application processing unit that executes the Web application. The server 200 executes the Web application with these elements to provide a Web service to the user of the information processing terminal 100. Since operations of the input screen request processing unit 212, the input screen transmission unit 214, the print job display unit 234, the print instruction reception unit 240, and the print execution instruction unit 242 are substantially the same as the operations according to the first embodiment explained above, explanation of the operations is omitted.

The management information reception unit 216A receives management information from the information processing terminal 100. The management information reception unit 216A may be implemented by, for example, the communication unit 206. The management information reception unit 216A may control the communication unit 206 to receive management information transmitted by the management information transmission unit 160A of the information processing terminal 100. The management information storage unit 218A stores the management information received by the management information reception unit 216A. The management information storage unit 218A may be implemented by the storage unit 204.

The identification information assigning unit 220A assigns identification information to the management information received by the management information reception unit 216A. As explained above, the identification information is information for identifying the management information. The identification information is information for distinguishing the management information corresponding thereto from other management information. In other words, the identification information is used to specify the management information. The identification information may be, for example, a unique identification number or may be, for example, a unique identifier. The identification information assigning unit 220A adds identification information to the management information stored in the management information storage unit 218A. Therefore, the management information stored in the management information storage unit 218A is associated with identification information for uniquely identifying the management information.

The identification information transmission unit 222A performs processing for transmitting the identification information of the management information to the information processing terminal 100. The identification information transmission unit 222A may be implemented by, for example, the communication unit 206. The identification information transmission unit 222A may control the communication unit 206 to transmit the identification information to the information processing terminal 100.

The job data reception unit 230A receives job data from the information processing terminal 100. The job data reception unit 230A may be implemented by, for example, the communication unit 206. The job data reception unit 230A receives the job image, the print condition added to the job image, and the identification information of the management information, which are included in the job data. Accordingly, the server 200 receives a print job.

The data integration unit 232A links the management information with the job image using the identification information and integrates the management information and the job image into one piece of job data. Specifically, the management information corresponding to the identification information included in the job data received by the job data reception unit 230A and the job image included in the job data received by the job data reception unit 230A are integrated into one file. More specifically, the data integration unit 232A extracts, from the management information storage unit 218A, the management information corresponding to the identification information included in the job data received by the job data reception unit 230A. The data integration unit 232A links the extracted management information and the job image included in the job data received by the job data reception unit 230A. Then, the data integration unit 232A integrates the management information and the job image into one file. The data integration unit 232A may generate the job data including the management information by incorporating the management information extracted from the management information storage unit 218A into the job data received by the job data reception unit 230A. Accordingly, in the second embodiment as well, job data including the same information as the job data according to the first embodiment is generated.

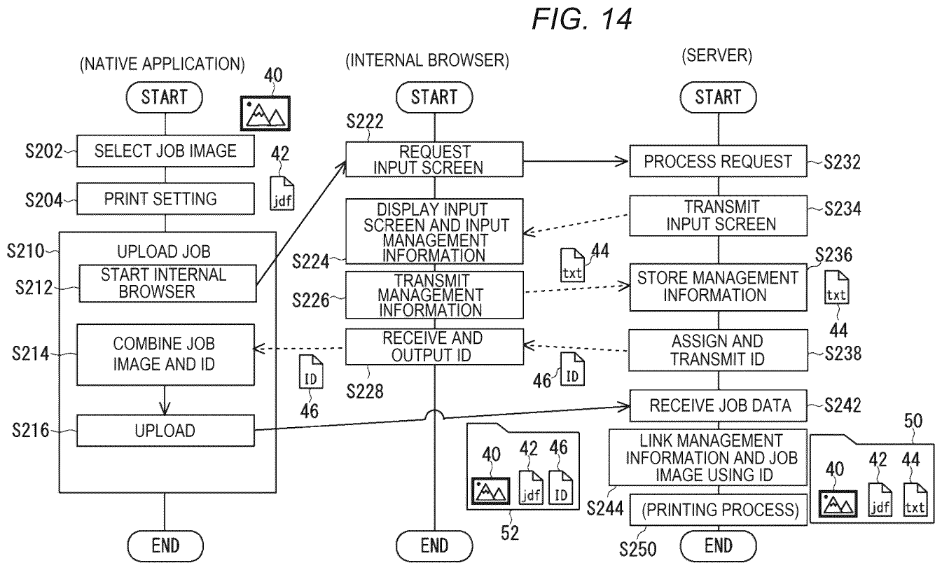

FIG. 14 is a sequence diagram illustrating processing executed by the management system 1 according to the second embodiment. The native application processing unit 120A of the information processing terminal 100 selects a printing target job image (step S202). This processing corresponds to the first step illustrated in FIG. 3 explained above. Specifically, as in the first embodiment, the job image reception unit 122 receives designation of the job image 40, which is a printing target image, according to operation of the user. Accordingly, the job image reception unit 122 selects the job image 40.

The native application processing unit 120A of the information processing terminal 100 performs print setting for the job image selected in the processing in S202 (step S204). This processing corresponds to the first step illustrated in FIG. 3 explained above. Specifically, as in the first embodiment, the print condition reception unit 124 receives a print condition for the job image 40 according to operation of the user and generates the print condition data 42.

The native application processing unit 120A of the information processing terminal 100 performs processing of job upload for uploading a print job for the job image 40 selected in the processing in the S202 (step S210). First, the native application processing unit 120A starts the internal browser (step S212). Specifically, as in the first embodiment, the internal browser start unit 126 starts the internal browser according to operation of the user.

The internal browser processing unit 150A of the information processing terminal 100 requests the server 200 to transmit an input screen (step S222). Specifically, as in the first embodiment, the input screen request unit 152 transmits, to the server 200, a screen request instruction including an address of the input screen, which is a Web application screen. The server 200 performs processing concerning the request made by the information processing terminal 100 (step S232). Specifically, as in the first embodiment, the input screen request processing unit 212 determines an input screen corresponding to the address indicated by the screen request instruction and extracts data indicating the input screen. The server 200 transmits the input screen to the information processing terminal 100 (step S234). Specifically, as in the first embodiment, the input screen transmission unit 214 transmits data indicating the extracted input screen to the information processing terminal 100.

The internal browser processing unit 150A of the information processing terminal 100 displays the input screen and receives input of management information (step S224). This processing corresponds to the second step illustrated in FIG. 3 explained above. Specifically, as in the first embodiment, the input screen display unit 154 causes the interface unit 108 to display the input screen transmitted from the server 200. Further, as in the first embodiment, the management information reception unit 156 receives the input of the management information according to operation of the user. Accordingly, the management information reception unit 156 generates management information 44.

The internal browser processing unit 150A of the information processing terminal 100 transmits the management information 44 to the server 200 (step S226). This processing corresponds to the third step illustrated in FIG. 3 explained above. Specifically, as explained above, the management information transmission unit 160A transmits the management information 44 to the server 200 using the function of the internal browser according to operation of the user.

The server 200 stores the management information 44 (step S236). Specifically, as explained above, the management information reception unit 216A receives the management information 44 from the information processing terminal 100. As explained above, the management information storage unit 218A stores the received management information 44.

The server 200 assigns identification information (ID) to the management information 44 and transmits the identification information 46 to the information processing terminal 100 (step S238). Specifically, as explained above, the identification information assigning unit 220A assigns the identification information 46 to the management information 44. As explained above, the identification information transmission unit 222A transmits the identification information 46 to the information processing terminal 100.

The internal browser processing unit 150A of the information processing terminal 100 receives the identification information 46 from the server 200 and outputs the identification information 46 to the native application processing unit 120A (step S228). Specifically, as explained above, the identification information reception unit 162A receives the identification information 46 from the server 200. As explained above, the identification information reception unit 162A outputs the identification information 46 received from the server 200 to the native application processing unit 120A.

The native application processing unit 120A of the information processing terminal 100 combines the job image 40 and the identification information 46 (step S214). Specifically, as explained above, the identification information acquisition unit 130A acquires the identification information 46 output by the identification information reception unit 162A. As explained above, the combining unit 132A combines the job image 40 and the identification information 46 to generate job data 52. As explained above, the print condition data 42 is added to the job image 40. Therefore, the job data 52 includes the job image 40, the print condition data 42, and the identification information 46.

The native application processing unit 120A of the information processing terminal 100 uploads a print job (step S216). This processing corresponds to the fourth step illustrated in FIG. 3 explained above. Specifically, the job data transmission unit 134A transmits the job data 52 including the job image 40, the print condition data 42, and the identification information 46 to the server 200. Accordingly, the print job concerning the job image 40 is uploaded to the server 200 without using the function of the internal browser.

The server 200 receives the job data 52 (step S242). Specifically, as explained above, the job data reception unit 230A receives the job data 52 including the job image 40, the print condition data 42, and the identification information 46 from the information processing terminal 100. The server 200 links the management information 44 and the job image 40 using the identification information 46 (step S244). Specifically, as explained above, the data integration unit 232A links the management information 44 and the job image 40 using the identification information 46. Accordingly, the data integration unit 232A generates the job data 50 including the job image 40, the print condition data 42 concerning the job image 40, and the management information 44.

Then, the server 200 executes a printing process concerning the print job corresponding to the job data 50 (step S250). Specifically, as in the first embodiment, the print instruction reception unit 240 receives a print instruction concerning a print job corresponding to the job data 50 by receiving operation of the printing operator on the Web application screen. The print execution instruction unit 242 transmits the instructed print job to the printing apparatus 300. Accordingly, the printing apparatus 300 performs printing for the transmitted print job.

Here, a relationship between the screen of the GUI exemplified in FIGS. 8 and 9 explained above and the processing in the sequence diagram explained above is explained. First, the native application screen Im1 exemplified in FIG. 8 is explained. As in the first embodiment, in the processing in S202, the user operates the selection button Im11 of the native application screen Im1 to select a file of the job image 40. As in the first embodiment, in the processing in S204, the user performs print setting using the print setting region Im14. Accordingly, the print condition reception unit 124 generates print condition data 42. The print condition data 42 is added to the job image 40. As in the first embodiment, in the processing in S212, when the upload button Im15 is pressed by operation of the user, the internal browser starts in the information processing terminal 100. Then, the Web application screen Im2 exemplified in FIG. 9 is displayed by the function of the internal browser.

Next, the Web application screen Im2 exemplified in FIG. 9 is explained. As in the first embodiment, in the processing in S224, the user performs operation on the Web application screen Im2 to input management information concerning the job image selected using the native application screen Im1. In the second embodiment, in the processing in S226, when the upload button Im28 is pressed by operation of the user, the management information input using the internal browser is transmitted to the server 200 by the function of the internal browser. In the processing in S228, the internal browser receives the identification information of the management information from the server 200. In the processing in S214, the native application combines the identification information with the job image selected using the native application screen Im1. In the processing in S216, the native application transmits job data including the job image and the identification information to the server 200. Accordingly, the print job concerning the job image selected using the native application screen Im1 is uploaded to the server 200. In the processing in S244, the server 200 links the management information and the job image using the identification information and generates job data including the management information and the job image. As explained above, the print job concerning the job image selected using the native application screen Im1 is automatically uploaded to the server 200 without the job image being selected again by the user using the Web application screen Im2.

As explained above, as in the first embodiment, in the second embodiment, the information processing terminal 100 transmits the job image to the server 200 using the function of the native application rather than the function of the internal browser. Therefore, as in the first embodiment, the information processing terminal 100 according to the second embodiment is capable of simplifying operation of the user compared with when it is necessary to perform the operation of selecting a job image again with the function of the internal browser. Therefore, in the second embodiment as well, it is possible to improve the convenience of the user.

The information processing terminal 100 according to the second embodiment transmits the management information to the server 200 using the function of the internal browser. Therefore, in the second embodiment, compared with the first embodiment, the internal browser does not need to output the management information to the native application. On the other hand, in the first embodiment, the server 200 does not need to link the management information and the job image using the identification information of the management information. Therefore, in the first embodiment, processing of the entire management system 1 is simplified compared with the second embodiment.

### Modifications

The present disclosure is not limited to the embodiments explained above and can be modified as appropriate without departing from the gist of the present disclosure. For example, the order of the kinds of processing in the flowchart and the sequence diagrams explained above can be changed as appropriate. One or more of the kinds of processing in the flowchart and the sequence diagrams explained above can be omitted.

In the first embodiment explained above, the information processing terminal 100 transmits the job data obtained by combining the job image and the management information to the server 200. However, the present disclosure is not limited to this configuration. The information processing terminal 100 according to the first embodiment only has to transmit the job image and the management information using the function of the native application and does not need to combine and transmit the job image and the management information.

Similarly, in the second embodiment explained above, the information processing terminal 100 transmits the job data obtained by combining the job image and the identification information of the management information to the server 200. However, the present disclosure is not limited to this configuration. The information processing terminal 100 according to the second embodiment only has to transmit the identification information together with the job image and does not need to combine and transmit the job image and the identification information.

In the second embodiment explained above, the server 200 assigns the identification information of the management information. However, the present disclosure is not limited to this configuration. The native application of the information processing terminal 100 may assign the identification information of the management information. For example, the identification information acquisition unit 130A of the information processing terminal 100 may assign the identification information of the management information.

In the embodiment explained above, the server 200 provides the print service. However, the present disclosure is not limited to this configuration. The server 200 may provide any service for executing any processing concerning a job for a job file uploaded from the information processing terminal 100. The job file is a processing target file in the service provided by the server 200. The server 200 may be a server that provides a service concerning processing executed in an apparatus that executes some processing on the job file, such as processing of a file. In this case, the server 200 may give, to the apparatus that executes some processing on the job file, an instruction for executing the processing. For example, the server 200 may provide a service for performing processing such as image editing or moving image editing on an image file. The server 200 may provide a service for performing processing of a file of a portable document format (PDF) or the like. In this case, the server 200 may execute a Web application concerning the service. Then, the server 200 may cause the information processing terminal 100 to display a Web application screen concerning the Web application. The server 200 may replace, for a job uploaded from the information processing terminal 100, a file of a job image with any job file and perform substantially the same processing as the processing in the embodiment explained above.

In the above case, the information processing terminal 100 may include a native application for performing some processing on the job file. Then, the information processing terminal 100 may replace the file of the job image with any job file and execute substantially the same processing as the processing explained in the embodiment above. That is, the information processing terminal 100 may execute a transmission method explained below. The information processing terminal 100 executes a first step of receiving designation of a processing target job file using a function of a native application operating on the information processing terminal 100. The information processing terminal 100 executes a second step explained below. In the second step, the information processing terminal 100 displays a Web application screen of a Web application provided in the server 200 using a function of an internal browser that cooperates with the native application. In the second step, the information processing terminal 100 receives, on the Web application screen, input of management information to be used for management of the job file, the designation of which has been received in the first step. The information processing terminal 100 executes a third step of transmitting, to the server 200, the management information, the input of which has been received using the function of the internal browser in the second step. The information processing terminal 100 executes a fourth step of transmitting the job file, the designation of which has been received in the first step, to the server 200 using the function of the native application without using the function of the internal browser.

In the example explained above, the program includes an instruction group (or software codes) for causing a computer to perform the one or more functions explained in the embodiments when the program is read in the computer. The program may be stored in a non-transitory computer-readable medium or a tangible storage medium. Not as a limitation but as an example, the computer-readable medium or the tangible storage medium includes a random-access memory (RAM), a read-only memory (ROM), a flash memory, a solid-state drive (SSD), or other memory techniques, a CD-ROM, a digital versatile disk (DVD), a Blu-ray (registered trademark) disk, or other optical disc storages, and a magnetic cassette, a magnetic tape, and a magnetic disk storage, or other magnetic storage devices. The program may be transmitted on a transitory computer-readable medium or a communication medium. Not as a limitation but as an example, the transitory computer-readable medium or the communication medium includes an electrical propagation signal, an optical propagation signal, an acoustic propagation signal, or propagation signals of other forms. The program is included in a program product.

What is claimed is:

1. A transmission method comprising:
a first step of receiving designation of a job image, which is a printing target image, using a function of a native application that operates in an information processing terminal;
a second step of displaying, using a function of an internal browser that cooperates with the native application, a Web application screen that is a screen of a Web application provided in a print server that is capable of communicating with the information processing terminal via a network and performs processing concerning printing for the job image and receiving, on the Web application screen, input of management information used for management of the job image, the designation of which was received in the first step;
a third step of transmitting, to the print server, the management information, the input of which was received in the second step using the function of the internal browser; and
a fourth step of transmitting, to the print server, the job image, the designation of which was received in the first step, using the function of the native application without using the function of the internal browser.

2. The transmission method according to claim 1, wherein, in the third step, the management information, the input of which was received using the function of the internal browser, is transmitted to the print server using the function of the native application.

3. The transmission method according to claim 2, wherein, in the third step and the fourth step, the management information and the job image are collectively transmitted to the print server using the function of the native application.

4. The transmission method according to claim 1, wherein, in the third step, the management information, the input of which was received using the function of the internal browser, is transmitted to the print server using the function of the internal browser.

5. The transmission method according to claim 4, wherein, in the third step and the fourth step, the management information and the job image are transmitted to the print server at different timings.

6. The transmission method according to claim 5, wherein
identification information is assigned to the management information at a timing before the fourth step, and
in the fourth step, the identification information is transmitted to the print server together with the job image.

7. The transmission method according to claim 1, wherein the job image designated in the first step is an image stored in the information processing terminal on which the native application operates.

8. The transmission method according to claim 1, wherein, in the first step, a print condition for the job image is received in addition to the designation of the job image using the function of the native application.

9. The transmission method according to claim 8, wherein, in the fourth step, the print condition is transmitted to the print server together with the job image.

10. The transmission method according to claim 1, wherein the management information includes at least one of an order name, an order number, a job name, a number of deliveries, a customer name, a relative priority level, and a delivery date concerning printing of the job image.

11. A non-transitory computer-readable storage medium storing a program for causing a computer to execute:
a first step of receiving designation of a job image, which is a printing target image, using a function of a native application that operates in an information processing terminal;
a second step of displaying, using a function of an internal browser that cooperates with the native application, a Web application screen that is a screen of a Web application provided in a print server that is capable of communicating with the information processing terminal via a network and performs processing concerning printing for the job image and receiving, on the Web application screen, input of management information used for management of the job image, the designation of which was received in the first step;
a third step of performing processing for transmitting, to the print server, the management information, the input of which was received using the function of the internal browser; and
a fourth step of performing processing for transmitting, to the print server, the job image, the designation of which was received in the first step, using the function of the native application without using the function of the internal browser.

12. A transmission method comprising:
a first step of receiving designation of a processing target job file using a function of a native application that operates in an information processing terminal;
a second step of displaying, using a function of an internal browser that cooperates with the native application, a Web application screen that is a screen of a Web application provided in a server that is capable of communicating with the information processing terminal via a network and performs processing concerning a job for the job file and receiving, on the Web application screen, input of management information used for management of the job file, the designation of which was received in the first step;
a third step of transmitting, to the server, the management information, the input of which was received in the second step using the function of the internal browser; and
a fourth step of transmitting, to the server, the job file, the designation of which was received in the first step, using the function of the native application without using the function of the internal browser.
